(19) United States
(12) Patent Application Publication
(10) Pub. No.: US 2019/0126532 A1
(43) Pub. Date: May 2, 2019

(54) METHOD FOR FORMING A RIBLET ON A COMPONENT AND RIBLET MOULD

(71) Applicant: SAFRAN, Paris (FR)

(72) Inventors: Nicolas Pierre LANFANT, Moissy-Cramayel (FR); Florence CASTAGNET, Moissy-Cramayel (FR); Thierry CHAUVIN, Moissy-Cramayel (FR); Emilie GONCALVES, Moissy-Cramayel (FR); Nicola PICCIRELLI, Moissy-Cramayel (FR); Loïc SORGNARD, Moissy-Cramayel (FR)

(73) Assignee: SAFRAN, Paris (FR)

(21) Appl. No.: 16/306,284

(22) PCT Filed: Jun. 2, 2017
(86) PCT No.: PCT/FR2017/051404

§ 371 Date: Nov. 30, 2018

(30) Foreign Application Priority Data
Jun. 3, 2016 (FR) 1655056

(51) Int. Cl. B29C 59/02; B29C 59/00; B64C 1/00; B64F 5/10

(52) U.S. Cl. CPC B29C 59/022; B29C 59/002; B64C 1/0009; B64C 2001/0072; B64C 1/00; B29C 2059/023; B64F 5/10

(57) ABSTRACT

Method for forming a riblet on a component and riblet mould. This invention relates to a method for forming a riblet (3) on a component (1), characterised in that it comprises steps of: printing (106) the riblet on the component (1), comprising applying a film (1) comprising a riblet imprint (6) on the component (1), and peeling (108) the film (4) so as to separate the riblet imprint (6) from the component (1), after printing (106). This invention also relates to a riblet mould (3), the mould comprising a film (4) in which a riblet imprint (6) is formed, the film (4) being adapted to be separated from a component (1) on which a riblet (3) has been printed by means of the riblet mould (3), by peeling the film (4).

### FIELD OF THE INVENTION

The present invention relates to a method for forming a riblet on a component, and a riblet mould.

### PRIOR ART

With reference to FIG. 1, a conventional component 1 designed to be immersed in a moving fluid comprises a surface 2 on which are formed riblets 3. Riblets 3 are microscopic grooves extending parallel to the direction of flow of the fluid, having the effect of reducing fluid friction at the surface 2 of the component 1 and, consequently, reducing the induced drag. Riblets 3 thus allow an improvement of the aerodynamic performance of the component 1.

Riblets 2 generally have a trapezoidal shape, in the shape of a slot or having a triangular shape as shown in FIG. 2. They are characterized by a height h, of the order of 10 to 50 μm, a width s of the same order of magnitude.

Several methods are known from the state of the art for forming riblets on the surface of a component.

According to a first known method, a riblet is first formed by calendaring on a support film, which is attached to a previously constituted component.

Such an attachment, however, has the disadvantage of requiring high accuracy. It is in fact necessary that the riblets be correctly oriented with respect to the direction of flow of the fluid in which the component is designed to be immersed.

However, if the support film is too rigid, it is difficult to attach it to the component. On the other hand, if the support film is too flexible, there exists a considerable risk of deforming the riblets during the application of this support film on a component of which the surface is not developable (risk of locally separating the grooves, of obtaining a direction deviating with respect to a given specification and of deforming the cross section of the riblets).

Moreover, the attachment of such a support film is particularly difficult on a component which has a complex shape, in particular a component requiring nonlinear riblets and in which the directions evolve along the surface of the component. The printing of riblets on a film cut to the shape of the component could be considered, but would make the installation of said film on the component even more complex.

There also exists the risk of crushing the riblets formed on the support film during its attachment to the component. To avoid such crushing, it has been proposed to install a protection liner during attachment. This liner, however, contributes high stiffness to the film and as in the preceding situation, it is difficult to apply the film on a curved or non-developable surface.

Finally, this first known method has as its other disadvantage necessitating dual control of the quality of the riblets, when the support film is supplied by the supplier: it is in fact appropriate to proceed with a first control of the supplied film, then with a second control after attachment to the component.

According to a second known method, the formation of riblets on a component is carried out by moulding, and more precisely during the moulding of the component itself.

An injection mould is used for moulding the component. The injection mould, which is relatively complex, comprises several blocks, at least one of these blocks comprising an imprint of the component (and particularly an imprint of the riblets). To mould the component, the mould is placed in the press and a resin is injected under pressure. Depending on the resin injected, maximum temperatures and pressures can be high and the stages can sometimes reach several hours. In these conditions, the injection mould is strongly stressed (it is in fact subjected to successive dilations and relaxations).

Now the operation of de-moulding the component is particularly delicate to implement.

In the first place, the presence of riblets on the component obtained at the conclusion of the injection increases friction between this component and the mould. To facilitate de-moulding, it has been proposed to use a mould release agent (with a thickness of a few tens of microns). However, the deposit of such a mould release agent is likely to affect the final shape of the riblets and therefore to degrade the aerodynamic performance of the component.

Secondly, de-moulding generates shear stresses on the riblets. FIG. 3 illustrates this shear phenomenon caused by the mould M on riblets 3 with triangular profiles. These stresses are likely to generate cracks in the bases of the riblets 3 or their crests. This affects the aerodynamic performance of the component before it is even put into service, and thereby puts the principle of riblets into question.

### DISCLOSURE OF THE INVENTION

One aim of the invention is to minimize the degradation of aerodynamic performance of a component including riblets during its manufacture.

Thus proposed, according to a first aspect, is a method of forming a riblet on a component comprising steps of printing the riblet on the component, comprising an application on the component of a film comprising a riblet imprint, and peeling the film so as to separate the riblet imprint from the component, after printing.

Also proposed therefore, according to a second aspect, is a riblet mould comprising a film in which is formed a riblet imprint, the film being adapted to be separated from a component, on which a riblet has been printed by means of the riblet mould, by peeling the film.

The flexible character of the film in which the riblet imprint is formed allows it to be withdrawn from the component once the riblet is printed, without however causing shear phenomena as great as those encountered with an injection mould is used, this regardless of the direction of peeling.

The riblet forming method can also comprise the following features, taken alone or in combination when that is technically possible.

The method can comprise insertion of the component in the interior of a vacuum bag, the printing comprising placing the vacuum bag under vacuum so that the vacuum bag presses the film against the component. The use of such a vacuum bag during printing is advantageous because the walls of the pouch exert a uniform pressure over the entire surface of the riblet imprint. The riblets thus obtained are therefore particularly regular, this even when the surface of the component considered has a complex shape (non-planar in particular).

The film can be a wall of the vacuum bag. There is therefore no need to insert a film into the vacuum bag in addition to the component on which the riblet must be formed, which simplifies the implementation of the method.

Printing can comprise pressing the film against the component by means of a toot situated at the exterior of the vacuum bag. The use of this tool allows additional pressure force to be applied in addition to that supplied by the vacuum bag.

Printing can comprise heating the component and the film, when the film is applied against the component.

Printing can comprise the application of an anti-erosion coating on the component, the riblet being printed in the anti-erosion coating.

The anti-erosion coating can consist of a paint and/or of a polymer.

The film can consist of an elastomer or of a polycarbonate.

The riblet forming on the component a groove extending in a longitudinal direction, the peeling of the film can be carried out along the longitudinal direction or following a direction perpendicular to the longitudinal direction. These two alternative peeling directions each allow a maximum reduction of the risks of residual shear of the printed surface of the component, and therefore allow perfectly aerodynamic riblets to be obtained.

The invention also relates to a vacuum bag comprising a pouch, a vacuum pump configured to aspirate the air contained in the pouch and a riblet mould according to the second aspect of the invention, the riblet imprint being formed in the internal surface of the pouch.

### DESCRIPTION OF THE FIGURES

Other features, aims and advantages of the invention will be revealed by the description that follows, which is purely illustrative and not limiting, and which must be read with reference to the appended drawings in which:

FIG. 1 illustrates in three-quarters view an aerodynamic component including riblets.

FIG. 2 shows a known type of riblets.

FIG. 3 is a section view of a portion of an injection mould, and of a riblet during de-moulding.

FIGS. 4 and 5 are flowcharts of steps of a method of forming a riblet on a component according to one embodiment of the invention.

FIG. 6 is a profile view of a riblet mould according to one embodiment of the invention.

FIG. 7 comprises two three-quarters views of a component during its manufacture in compliance with a method according to one embodiment of the invention.

FIG. 8 comprises four section views of a component and of a mould used for printing riblets on the component, in compliance with an embodiment of the invention.

FIG. 9 is a section view of a riblet mould and of a riblet during a de-moulding step according to a first embodiment of the invention.

FIG. 10 is a three-quarters view of a riblet mould and of a riblet during a de-moulding step according to a second embodiment of the invention.

In all the figures, similar elements bear identical reference symbols.

### DETAILED DESCRIPTION OF ONE EMBODIMENT OF THE INVENTION

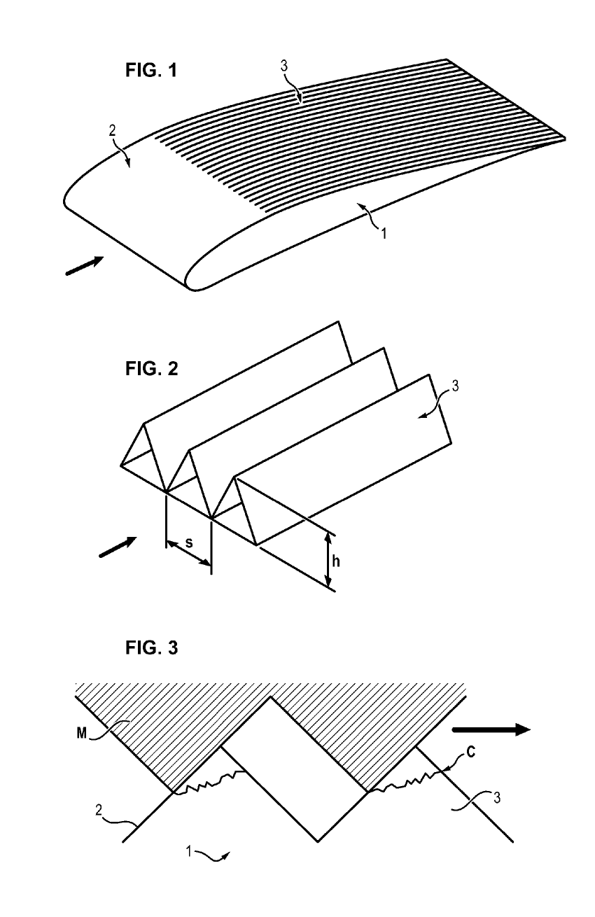

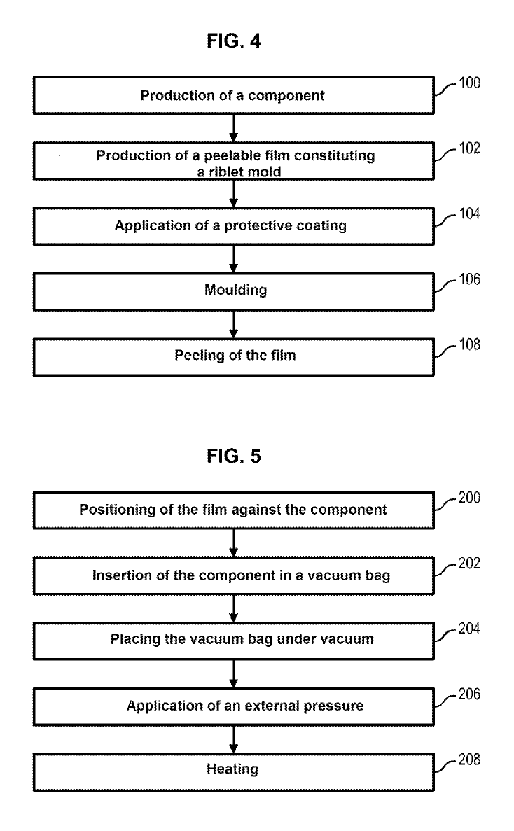

With reference to FIG. 4, an aerodynamic component like that shown in FIG. 1 already discussed, is manufactured by means of the following steps.

A raw component 1 comprising a surface 2 on which it is desired to form riblets 3 is manufactured in a step 100. The component 1 is for example a portion of a fuselage of an aircraft.

This manufacture 100 is implemented by casting, but machining a metallic in the mass, by moulding, by stamping for a composite component, etc.

A film 4 comprising a first surface 5 in which a riblet imprint 6 is formed is manufactured in a step 102.

The riblet imprint 6 has a profile complementary to that of a riblet 3.

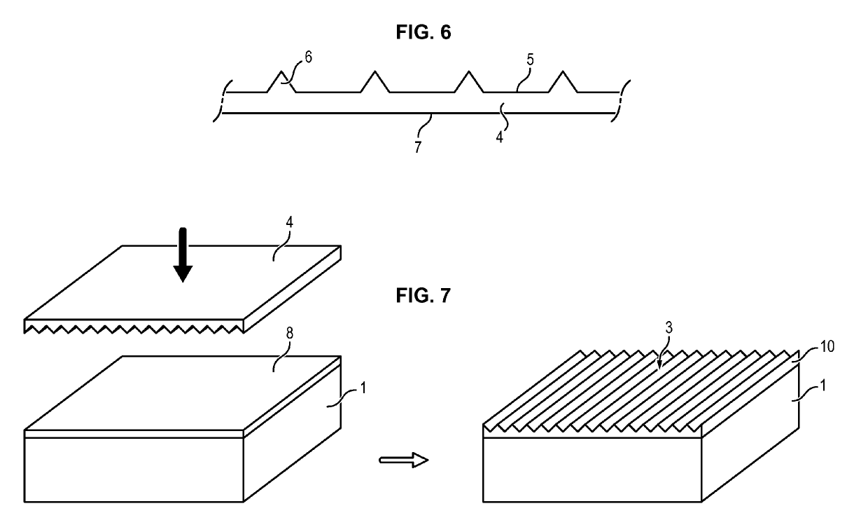

For example, in an embodiment shown in FIG. 6, the riblet imprint 6 comprises a plurality of ribs with a triangular profile. The ribs extend parallel to one another. The ribs are spaced from one another by planar portions of the surface 5. Other forms of riblet imprint 6, adapted to print riblets of different shapes (slot-shaped or trapezoidal) can of course be used.

The film 4 also has a second surface 7 opposite to the first surface 5. The second surface 7 is planar.

The film 4 has suitable stiffness so that the film is not deformed during application and during pressurization at 5 bars, and to resist manual traction during a peeling step which will be described below.

The film 4 is flexible enough to contact the entire surface of the component (taking into account, for example, shrinkage cavities potentially present on the surface of composite components).

The film 4 consists for example of elastomer, for example silicone or fluoropolymer or polyurethane. Alternatively, the film 4 is made of polycarbonate, which is a more rigid material than an elastomer. As a variant, the film 4 consists of a polymer or a metal.

The film 4 has a thickness between its two opposite surfaces 5 and 7 comprised between 0.1 and 0.5 millimetres, preferably 0.3 millimetres.

In a step 104, an anti-erosion protective coating 8 is applied to the surface 2 of the component 1.

The application of this anti-erosion coating 8 comprises a preliminary preparation of said surface 2. This preparation comprises sandblasting, degreasing and/or sanding of the surface 2 of the component 1. This preparation has the effect of improving the adhesion of the anti-erosion coating on the surface 2 of the component 1.

A solution is applied to the surface 2 thus prepared so as to form the anti-erosion coating.

The anti-erosion coating 8 consists of a material capable of being marked when pressure is applied to it.

The anti-erosion coating 8 can consist of a polymer film (polyurethane or fluoropolymer for example), or of a thermoplastic material. The anti-erosion coating 8 can also be a paint.

The anti-erosion coating 8 is attached to the surface 2 of the component 1 by gluing, for example by means of a film of glue, with an adhesive primer in the case of a metal component 1.

Riblets 3 are then printed 106 onto the anti-erosion coating 8 applied to the component 1 using the film 4.

In a particular embodiment, of which the steps are illustrated in FIG. 5, the printing comprises the following sub-steps.

The film is positioned 200 with respect to the component 1, so that the riblet imprint 6 formed in the film 4 faces the anti-erosion coating 8 as shown in FIG. 7.

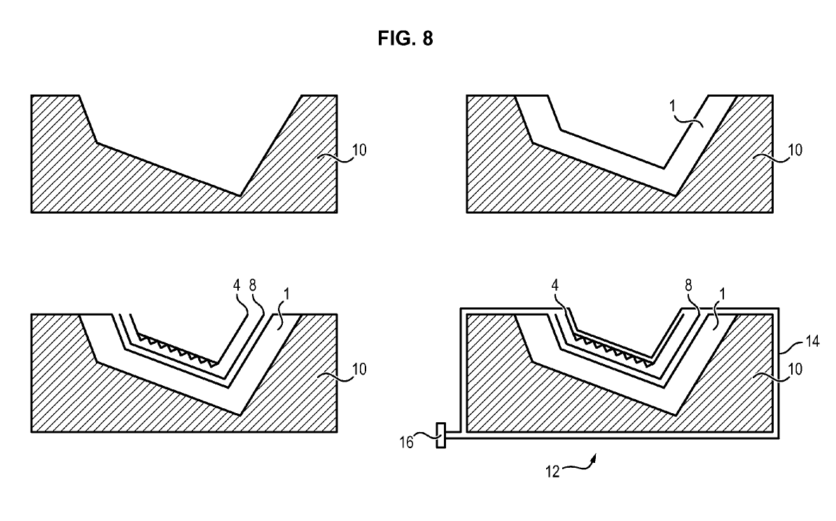

For example, as shown in FIG. 8, the component is placed in a cavity of a support element 10, made of foam for example. The first surface 5 of the film 4 is positioned facing the anti-erosion coating 8 previously applied to the component 1. In this manner, the component 1 is sandwiched between the support element 10 and the film 4.

In a manner known in se, a vacuum bag 12 comprises a pouch 14 and a vacuum pump 16 configured to aspirate the air contained in the pouch 14 and to draw a vacuum there.

The component 1 is inserted into the interior of the pouch 14 of the vacuum bag 12, likewise the film 14.

The vacuum bag is placed under vacuum during a step 204 white the component 1 and the film 4 are located in the interior of the pouch 14. To this end, the vacuum pump 16 is activated so as to aspirate the air in the interior of the pouch 14. Thanks to this aspiration, the walls of the pouch 14 of the vacuum bag 12 are pressed against the second surface 7 of the film 4. The riblet imprint 6 formed in the first surface 5 of the film 4, opposite to the surface 7, is then stressed so as to print riblets 3 into the anti-erosion coating 8. The riblets 3 have a shape complementary to that of the riblet imprint 6.

Although it is optional, the use of the vacuum bag 12 during the printing 106 is advantageous because the walls of the pouch exert a uniform pressure over the entire surface of the riblet imprint 6. The riblets 3 thus obtained are therefore particularly regular, this even when the surface 2 has a complex shape (non-planar in particular).

In addition, pressure can be exerted 206 by means of a pressing toot situated at the exterior of the vacuum bag 12. The toot presses against the external surface of the pouch 14; the pouch 14 then presses against the second surface 7 of the film 5 contained in the pouch, and the riblet imprint 6 formed on the surface 5 is impressed with greater force into the anti-erosion coating 8. The pressing toots comprises for example a screw and/or ram system.

The pressure of the riblet imprint 5 against the anti-erosion coating 8 (generated by the vacuum pump 16 and/or the pressing tool situated at the exterior of the pouch 14) is maintained for a period of predetermined length.

The film 5 and the component 1 can also be heated 208 and maintained at a printing temperature, during this period of predetermined length.

For example, the pouch 14 of the vacuum bag 12 containing the film 5 and the component 1 is placed in an oven implementing the heating 208.

Alternatively, the heating 208 is implemented prior to the printing 106. This is advantageous for softening the anti-erosion coating 8, when it has solidified on the surface 2 of the component 1. Such solidification can for example occur typically in the case where the anti-erosion coating 8 is a paint or consists of a thermoplastic.

The vacuum bag 12 is then opened. A block consisting of the component 1, the anti-erosion coating 8 and the film 4 is withdrawn from the pouch 14.

The shape of the riblets 3 printed on the anti-erosion coating 8 complies with the prior art. The riblets 3 thus form grooves extending along a longitudinal direction X, complementary to the ribs of the riblet imprint 6. Hereafter the example of riblets 3 with a triangular profile will be used. In the case where the surface 2 is planar the riblets 3 have crests parallel to the longitudinal direction X.

The component is then de-moulded, i.e. the component is separated from the film used during the printing 106.

De-moulding comprises peeling the film 4 so as to separated it from the anti-erosion coating 8, and thus reveal the riblets 3 formed in the anti-erosion coating 8.

Peeling consists of clamping one end of the film 4, manually or using a gripping tool, and displacing this end of the film 4 with respect to the component 1 so as to deform the film 4 and progressively reveal in one direction, hereafter called the peeling direction, the riblets 3 formed on the component 1.

The flexible character of the film 4 in which the riblet imprint 5 is formed allows a very significant reduction in the shear phenomena encountered when an injection mould is used, this regardless of the peeling direction selected.

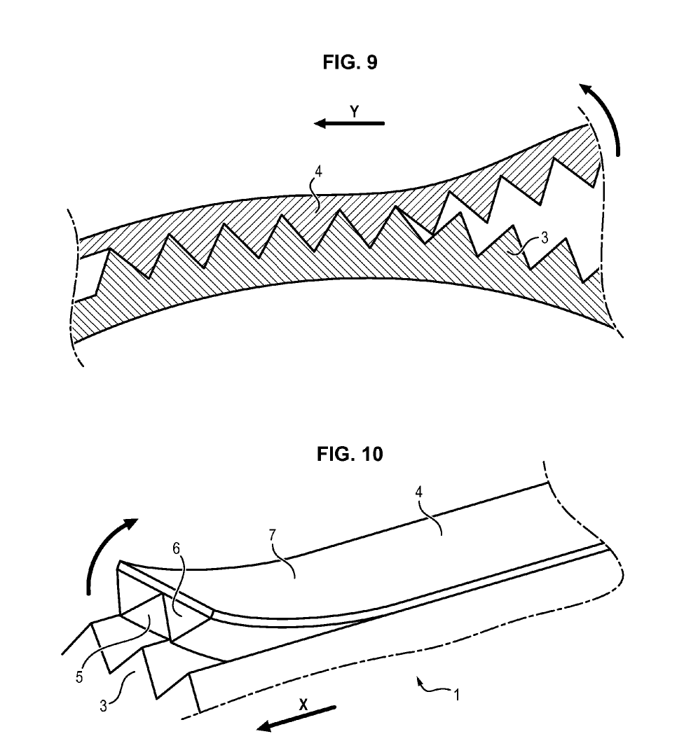

As illustrated in FIG. 9, the peeling direction can be a direction Y orthogonal to the longitudinal direction X of the riblets 3. In a variant illustrated in FIG. 10, the peeling direction is the longitudinal direction X of the riblets 3. These two peeling directions X or Y each allow a maximum reduction of residual sheer, and therefore allow perfectly aerodynamic riblets 3 to be obtained.

Moreover, the peeling 108 can be manual or assisted, regardless of the selected peeling direction.

When the film 8 consists of a polymer, the film 8 has a resistance and a flexibility particularly suited to allow its withdrawal by peeling while maintaining the structure of the riblets 3 (few constraints are then exerted on the riblets 3).

One advantage of the method thus implemented is that the quality can be controlled only once (after the peeling step 108). The improvement of the quality of the riblets and of the repeatability of installation also allows increasing the frequency of sampling. Increasing the frequency of sampling therefore also allows reducing the cost of production of the component.

The invention is not limited to the embodiments described in relation with the figures, but can be subject to other variants.

The riblets 3 can be directly formed in the surface 2 of the component, and not in an anti-erosion coating 8. In such a variant, the component can be previously heated, so that the material in which the surface 2 is formed is sufficiently softened so that the riblets 3 can be printed 106 on it.

As a variant, the film 4 is a component of the pouch of the vacuum bag. The first surface 5 in which the riblet imprint 6 is formed can be a portion of the internal surface of the pouch 14 of the vacuum bag 12. In such a variant, there is no need to insert a film 4 in the interior of the vacuum bag 12, which simplifies the implementation of the printing 106 of the riblets 3.

In another variant, no vacuum bag is used for pressing the film 4 on the component 1. This pressing is implemented using other pressing means.

1. A method for forming a riblet on a component, wherein the method comprises:
inserting the component in a vacuum bag,
printing the riblet on the component, wherein said printing comprises placing the vacuum bag under vacuum by aspiration of the air contained in the vacuum bag using a vacuum pump so that, thanks to the aspiration, the vacuum bag presses a film comprising a riblet imprint against the component,
peeling the film so as to separate the riblet imprint from the component, after printing.

2. The method according to claim 1, wherein the film is a wall of the vacuum bag.

3. The method according to claim 1, wherein printing the riblet comprises pressing further the film against the component using a tool situated outside the vacuum bag.

4. The method according to claim 1, further comprising heating the component and the film while the film is applied against the component.

5. The method according to claim 1, comprising applying an anti-erosion coating on the component, wherein the riblet is printed in the anti-erosion coating.

6. The method according to claim 5, wherein the anti-erosion coating consists of a paint and/or of a polymer.

7. The method according to claim 1, wherein the film consists of an elastomer or of a polycarbonate.

8. The method according to claim 1, wherein the riblet forms on the component a groove extending along a longitudinal direction, and wherein the peeling of the film is carried out along the longitudinal direction or following a direction perpendicular to the longitudinal direction.

9. A vacuum bag comprising
a pouch,
a vacuum pump configured to aspirate the air contained in the pouch and
a riblet mould comprising a film in which is formed a riblet imprint, the film being adapted to be separated from a component on which a riblet has been printed using the riblet mould, by peeling the film, the riblet imprint being formed in the internal surface of the pouch (14).
